(19) United States
(12) Patent Application Publication
(10) Pub. No.: US 2022/0319119 A1
(43) Pub. Date: Oct. 6, 2022

(54) REAL-TIME AUGMENTED REALITY EVENT-BASED SERVICE

(71) Applicant: NCR Corporation, Atlanta, GA (US)

(72) Inventors: Anisha Bhogale, Chester Springs, PA (US); Gina Torcivia Bennett, Lawrenceville, GA (US); Caleb Wayne Martinez, Fayetteville, GA (US); Kip Oliver Morgan, Atlanta, GA (US)

(21) Appl. No.: 17/218,295

(22) Filed: Mar. 31, 2021

(51) Int. Cl. G06T 19/00; G06Q 30/06; G06Q 10/08; G06Q 20/08; G06Q 20/38; G06Q 50/00; G06Q 30/02; G06Q 20/32; G06F 9/54

(52) U.S. Cl. CPC G06T 19/006; G06Q 30/0643; G06Q 10/083; G06Q 20/085; G06Q 20/384; G06Q 50/01; G06Q 30/0201; G06Q 20/321; G06F 9/541; H04L 67/10

(57) ABSTRACT

A real-time cloud-based Augmented Reality (AR) service is provided for events. The service visually and audibly integrates remote participants into event-based locations and event-based devices during an event via participant-operated devices. The service further permits remote ordering of items and/or services by the participants. The items and/or services are actual items and/or services which are being offered at an event venue for the event to in-person event participants. Further, the service renders images of any ordered items/services on AR generated objects of the participant-operated devices. Moreover, the service places the orders with the appropriate vendors and schedules delivery of the ordered items/services to coincide with participant-defined times before, during, and/or after the event.

### BACKGROUND

COVID19 has dramatically changed behaviors of consumers and retailers. Consumers and retailers are now vastly more aware of health safety, which is designed to mitigate the spread of the virus. For example, consumers have been encouraged to stay at home and when they are unable to stay at home wear facial coverings and keep at safe physical distances from others while in public in order to prevent virus transmission. Retailers have reduced consumer capacity, put physical barriers between consumers while dining, labeled floors with markers to inform consumers in line what a safe distance is considered to be, etc.

All of this social distancing has come at a cost, more consumers than ever are reporting mental health issues from the lack of social interaction. Keeping professional sports going was an important outlet for consumers even though fans were completely or largely restricted from attendance. But the visual of cardboard cut-out fans sitting in seats or the visual of little to no fans in the seats while watching the games on television was unappealing to most fans. It has become apparent that there is a wide array of sensory experiences which contribute to the overall fan experience during a game. In fact, the experience begins before the game and continues after the game for most fans.

Even before the pandemic, many consumers were unable or unwilling to attend sporting events in person for a variety of reasons, such as physical disabilities, geographical locations of the events, transportation concerns, high-ticket prices, limited availability of tickets, etc. Also, some consumers who frequented sporting events before the pandemic may be unwilling to attend in-person sporting events over lingering fears of catching the virus (even after receiving a vaccination).

As a result, and for a variety of reasons, professional sports are struggling to maintain, expand, and engage their fan bases. A variety of new strategies have been deployed with limited success. For example, many broadcasters now allow fans to place wagers for free on aspects of a game to win cash awards. The belief is that fans will be more engaged and watch the games if they have a chance to win some money just by watching. Broadcasters have also started showing videos of fans in their houses having their own personal game parties with their team's spirit wear with the belief that this will generate enthusiasm and excitement for the broadcast.

### SUMMARY

In various embodiments, methods and a system for real-time Augmented Reality (AR) event-based service are presented.

According to an embodiment, a method for real-time AR event-based service is provided. For example, items that are being provided by vendors at an event location for an event are identified. AR objects representing the items are obtained and rendered on an AR concession stand object within an AR interface. First AR objects are selected from the AR concession stand object within the AR interface and the first AR objects are rendered on an AR table object within the AR interface. First items that correspond to the first AR objects are scheduled for delivery to a designated location and at a designated time that coincides with a state of the event based on delivery instructions received through the AR interface.

### BRIEF DESCRIPTION OF THE DRAWINGS

FIG. 1A is a diagram of a system for real-time AR event-based service, according to an example embodiment.

FIG. 1B is a diagram an overview of AR-based ordering during an event, according to an example embodiment.

FIG. 1C is a diagram depicting an ordering from an AR rendered concession stand, according to an example embodiment.

FIG. 1D is a diagram depicting AR-based table and item rendering based on ordered items for an event, according to an example embodiment.

FIG. 1E is a diagram depicting ordering and social media cash link sharing from an AR rendered table of items for an event, according to an example embodiment.

FIG. 1F is a diagram depicting AR population of event members into empty event seats during an event, according to an example embodiment.

FIG. 1G is a diagram depicting AR rendered integration of spirit teams during an event, according to an example embodiment.

FIG. 1H is a diagram depicting rendering of an event member integrated into event devices during the event, according to an example embodiment.

FIG. 1I is a diagram depicting for integrating hawkers of items into devices of event members during an event, according to an example event.

FIG. 1J is a diagram depicting touch-based customized delivery times for items to event members during an event, according to an example embodiment.

FIG. 2 is a diagram of a method for mobile navigational control of a terminal's UI, according to an example embodiment.

FIG. 3 is a diagram of another method for mobile navigational control of a terminal's UI, according to an example embodiment.

### DETAILED DESCRIPTION

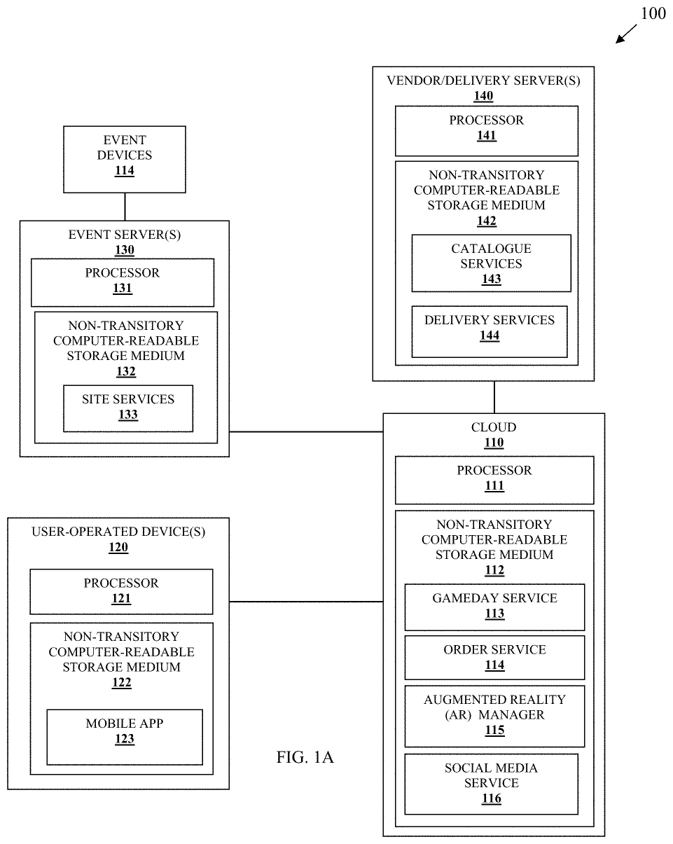

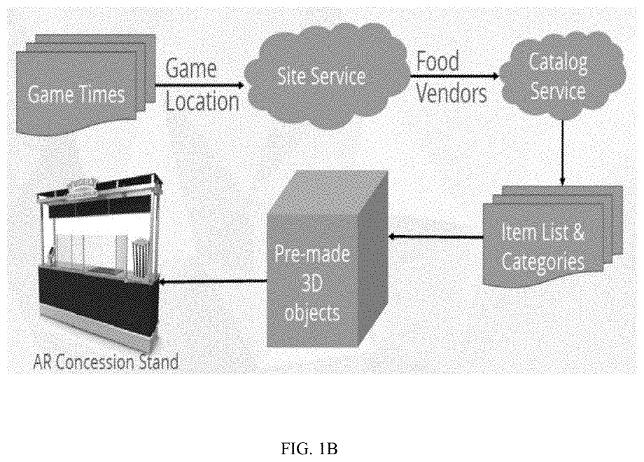

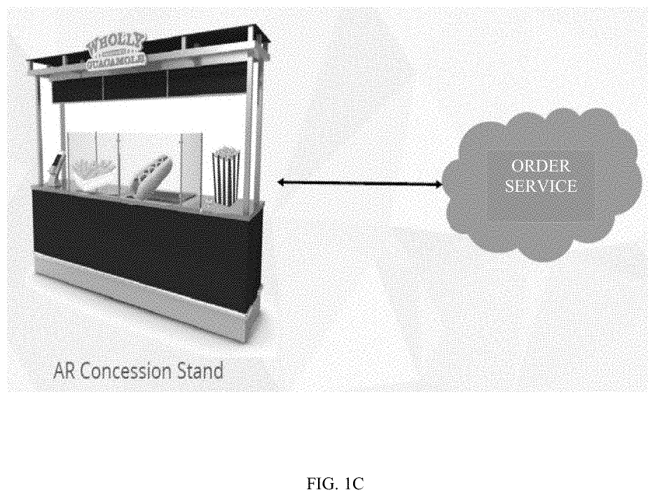

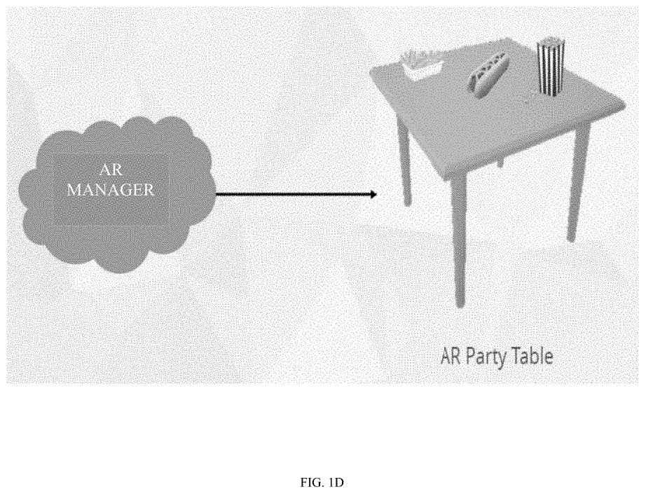

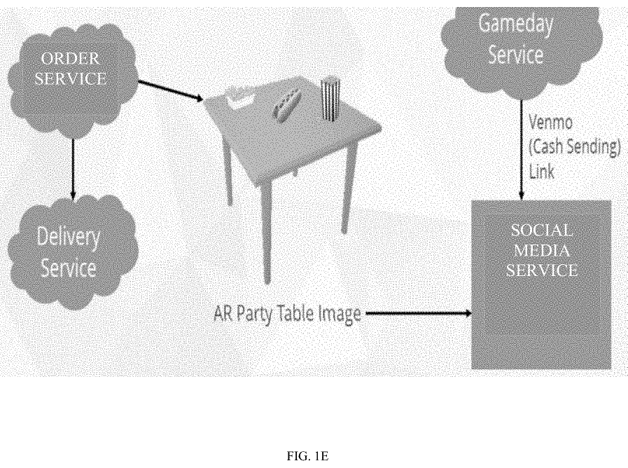

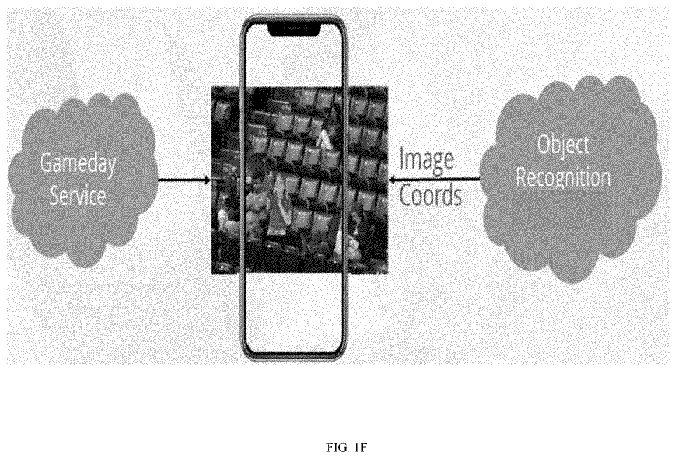

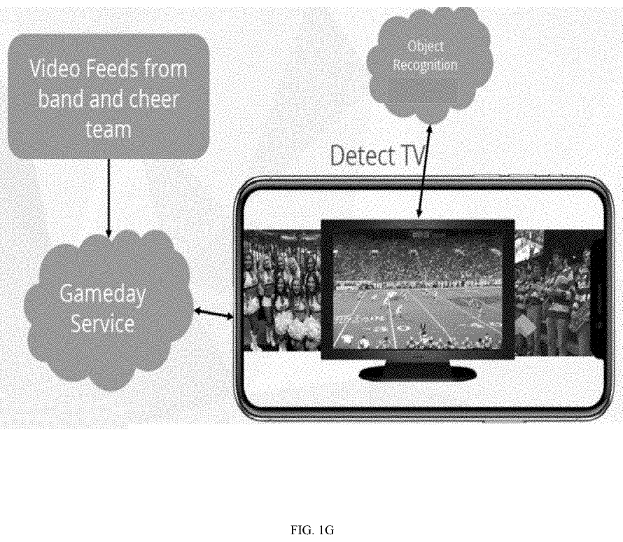

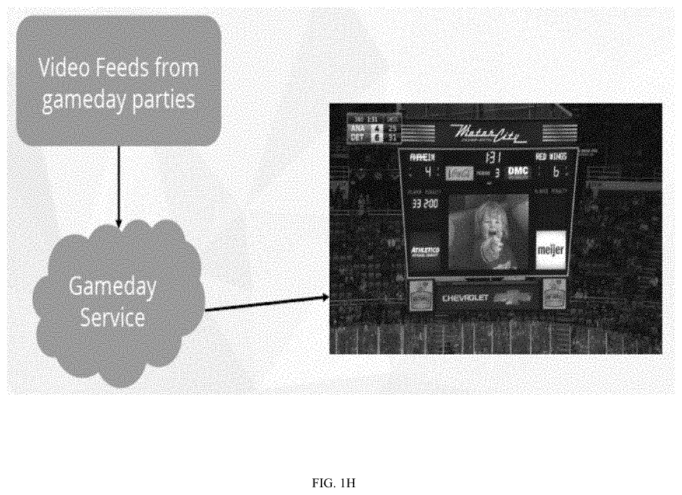

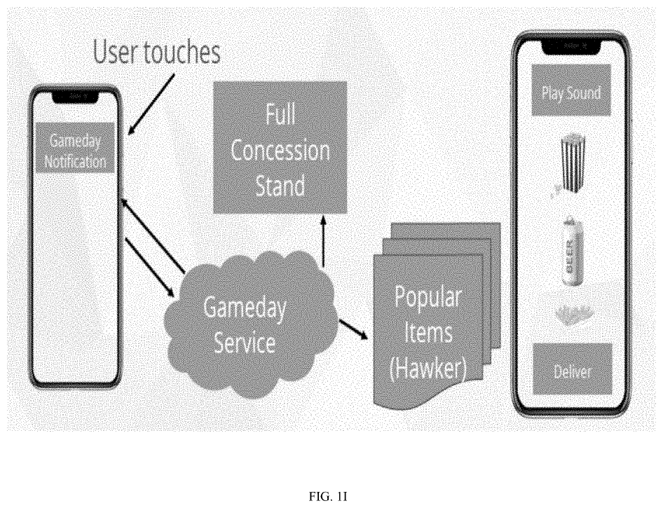

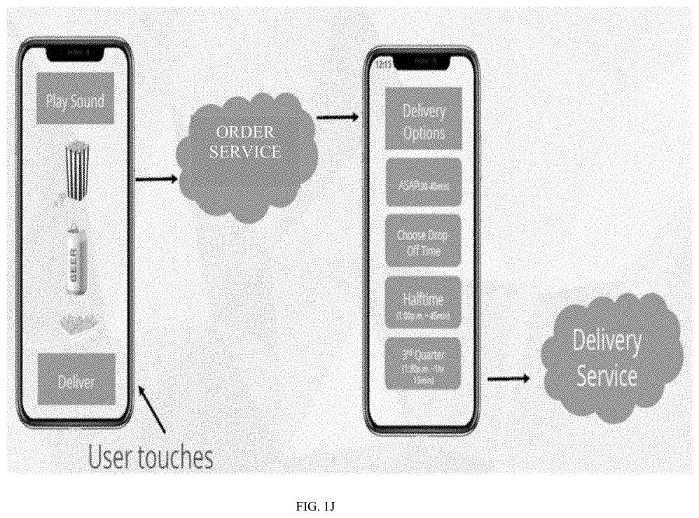

FIG. 1A is a diagram of a system 100 for real-time AR event-based service, according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of real-time AR event-based services, presented herein and below.

As will be discussed herein and below, methods and a system 100 are provided for real-time AR event-based services. A mobile-application for a user-operated device interacts an AR event-based and cloud-based service that allows users to self-organize as a group for an event, plan for the event, and actively participate before, during, and/or after the event using AR so that the user's experience is similar to an in-person experience with members of the group and with the event venue. Actual items and services offered at the event venue are offered for ordering and delivery to the group. The items and services are visually presented on AR rendered objects on a display associated with a user-operated device. The items and services are ordered from vendors and scheduled to be delivered to the user at times that coincide with the event as defined by the user. The user can have images of the user rendered in empty seats of the event venue along side with other members of the group. Spirit members for the teams can be visually superimposed alongside with the event as the event is being played. The spirit members can be pre-recorded or stream live in real time to the group/party. Event jumbotrons can actually present or appear to present members of the group during the broadcast of the event. Virtual hawkers can pitch items and services during the event to the members of the group. In fact, a variety of AR-based features are provided through system 100 (herein and below) to the members of the group for purposes of making the event experience as life-like and actual as possible for the members of the group.

As used herein the terms “user,” “fan,” and/or “virtual participant” may be used interchangeably or synonymously. These terms refer to members of a group that are virtually participating in an event (before, during, and/or after the event).

An “event” refers to a sports game, a concert, and/or a rally associated with a real-world gathering of participants assembled to watch and listen to a performance and/or a contest (game play).

The phrase “Augmented Reality (AR)” refers to an interactive experience with a real-world environment where some real-world objects appear as they are in the real-world environment and other objects that appear to be present within the real-world environment are computer generated, such that the real-world environment is augmented or enhanced.

System 100 includes a cloud 110 (a set of logically organized and cooperating servers accessible as a single server), user-operated devices 120, event servers 130, and vendor/delivery servers 140.

Cloud 110 comprises a processor 111 and non-transitory computer-readable storage medium 112. Medium 112 comprises executable instructions for a game day service 113, an order service 114, an AR manager 115, and a social media service 116. The executable instructions when executed by processor 111 from medium 112 causes the processor 111 to perform processing discussed herein and below for 113-116.

Each user-operated device 120 comprises a processor 121 and a non-transitory computer-readable storage medium 122. Medium 122 comprises executable instructions for a mobile application (app) 123. The executable instructions when executed by processor 121 from medium 122 cause processor 121 to perform processing discussed herein and below for mobile app 123. It is also to be noted that each user-operated device 120 may comprise a variety of integrated peripheral devices, such as a touch display, a camera, a speaker, a microphone, a Global Positioning Satellite (GPS) receiver, etc.

Each event server 130 comprises a processor 131 and a non-transitory computer-readable storage medium 132. Medium 132 comprises executable instructions for site-based (site) services 133. The executable instructions when executed by processor 131 from medium 132 causes the processor 131 to perform processing discussed herein and below for site services 133. Some site services 133 may control and interact with event devices 144 located at an event venue for the event during the event performance or contest.

Each vender/delivery server 140 comprises a processor 141 and a non-transitory computer-readable storage medium 142. Medium 142 comprises executable instructions for catalogue services 143 and delivery services 144. The executable instructions when executed by processor 141 from medium 142 cause the processor 141 to perform the processing discussed herein and below for 143-144.

Mobile app 123 provides a user-facing interface for interacting with gameday service 113. The user-facing interface may be touch-based, voice-based, or a combination of both touch-based and voice-based.

A user registers for an account with gameday service 113 through app 123. After registration, the user is presented with a schedule and list of available events along with dates and times and/or the user may search for specific events. The user selects an event and may further define a group or users or join an existing group of users already scheduled to AR participation in the selected event. Gameday service 113 sends in-app messages and/or social media messages to invite users not already part of the group. A group may also have a variety of user-defined permissions that govern who in the group is a leader or organizer, who can order or authorizing ordering for the group, etc. Gameday service 113 enforces the permissions against the users of the group.

FIG. 1B is a diagram an overview of AR-based ordering during an event, according to an example embodiment.

Once the event is selected, gameday service 113 obtains an event identifier for the event and an event location for the event, and gameday service 113 contacts the corresponding site service 133 using the event identifier to obtain event times and obtains vendor identifiers for food/spirit wear vendors scheduled for the event at the event location and event time. Next, gameday service 113 uses the vendor identifiers to contact catalogue services 143 and obtain a listing of items and categories of items or services being offered by the corresponding vendor for the event.

Each item being offered is mapped to a pre-defined three-dimensional (3D) object based on item identifiers obtained from catalogue service 143. A 3D object associated with a concession stand is also obtained.

FIG. 1C is a diagram depicting an ordering from an AR rendered concession stand, according to an example embodiment.

The 3D concession stand object is then rendered through app 123 by AR manager 115 on a display associated with user-operated device along with the 3D objects associated with the items being offered to presentation and selection by the users of the group.

As the users select items for the event, gameday service 123 provides the item identifiers and vendor identifier for obtaining the real-world items along with a group and event identifiers to order service 114. Order service 114 then uses an Application Programming Interface (API) and places the order with the corresponding service.

FIG. 1D is a diagram depicting AR-based table and item rendering based on ordered items for an event, according to an example embodiment.

As one or more of the users, select items rendered on the concession stand through the user-facing interface of app 123, the item objects are rendered on an AR party table object by AR manager 115 so that members of the group can visualize what has been ordered for the event.

Gameday service 113 may then send an invite out to members of the group along with the AR rendered image of the party table and items ordered. The invite may also include a selfie image of the group organizer with the party table and items.

FIG. 1E is a diagram depicting ordering and social media cash link sharing from an AR rendered table of items for an event, according to an example embodiment.

The organizing user of the group or an authorized user, can then pay for the ordered items and use app 123 for scheduling a specific user-defined delivery time of the ordered items. Gameday service 113 uses an API to interact with an appropriate delivery service 144 based on a delivery location provided by the user to schedule the items for delivery to the delivery location.

Once the items are ordered, paid for, and scheduled for delivery at the user-designated time, the user who organized the group or an authorized user according to permissions may then request that gameday service 113 request contributions from users of the group for payment of the ordered items. Gameday service 113 sends a cash sending link (such as Venmo® link) along with details of prices for the items to the group of users via social media service 116. Users may register their social media identifiers, such that gameday service 113 sends a social media message with the link to the specific users via a social media account held by the gameday service 113 and used for requesting contributions of the specific users for the items ordered.

It is noted that the time of delivery can be based on a specific point in time associated with the event. For example, the user may designate that the delivery time to be a half hour before the start of the event, halftime (e.g., event that is for a football game), end of first quarter, end of game, seventh inning (e.g., baseball game), etc. So, the user-defined delivery time can be relative to a point in time associated with the event. In this way, if the event is delayed for any reason (because of weather or because of a prior game that goes into overtime delaying the start of the game associated with the party), the group receives their delivery of ordered items at an appropriate desired time relative to the event's progress.

FIG. 1F is a diagram depicting AR population of event members into empty event seats during an event, according to an example embodiment.

As the event is progressing and the group is watching, the broadcast may show images of the stands with empty seats. Users can use app 123 and an integrated game of device 120 to stream the images from the broadcast and request that gameday service 113 superimpose images of members of the group into the empty seats on a display associated with device 120.

For example, users may upload selfies taken of themselves through app 123. When a user streams a video of the game (event) showing empty seats, app 123 provides an option for the user to insert their selfie onto the empty seat as illustrated in FIG. 1F. Any group member that provided the selfies, may also have their images superimposed in the empty seats together with other members of the group, such that it appears that the group is physically sitting in the seats during the game with one another. These AR visual images that depict the actual event seats and the superimposed group members can be viewed by each member of the group on their devices 120. The video clips associated with the members appearing together and seated at the game can be saved and replayed whenever requested during the event by the members of the group.

FIG. 1G is a diagram depicting AR rendered integration of spirit teams during an event, according to an example embodiment.

App 123 may also detect when a user is capturing the broadcast of the event and augment the event performance with additional video streams placed on sides of the captured broadcast. The video feeds added to the sides of the captured broadcast for the event can be pre-recorded or live. For example, live cameras (one type of event device 114) may provide a continuous video feed of the spirit members at the game or the band, such that gameday service 113 obtains these live feeds through site services 133 and augments the screen rendered on device 120 to includes selected feeds by the user to the sides of the real-time video broadcast of the event. The various live feeds may include a continuous stream of empty seats, which are augmented to include members of the group as was discussed above. Videos may also be pre-recorded with green screen backgrounds, such that the pre-recorded video is augmented with a background associated with a live feed to make it appear as if the pre-recorded video is live during the event. For example, a performance of a spirit team or the band may be pre-recorded with a green screen background and gameday service 113 provides options through app 123 for users to augment a video capture of the broadcast with the pre-recorded performance to make it appear as if it is live while the event is being played in real time.

FIG. 1H is a diagram depicting rendering of an event member integrated into event devices during the event, according to an example embodiment.

Live captured video feeds of the party of users or pre-recorded video feeds can also be superimposed on broadcasted video of the event's jumbotron (another type of event device 114). These video feeds and images can be selected as options for playing via app 123 on device 120. This makes it appear as if the party and/or users are being displayed live at the game on the jumbotron during the event. Again, a camera (type of event device 114) may provide a continuous video stream of the jumbotron allowing the users to substitute pre-recorded or live video streams of the users on the jumbotron. Thus, the current score and time remaining in the game may appear to be up to date to the users while at the same time the event location appears to be actually displaying the users live at the game.

FIG. 1I is a diagram depicting for integrating hawkers of items into devices of event members during an event, according to an example event.

During the event, gameday service 113 may provide audio and an option for hawkers (in-game vendors) pitching items for sale. This may be pre-recorded audio, which is played on a speaker of device 120 while images of the items being sold are displayed. The app 123 permits the users to order or have the items delivered upon request through delivery options and play the audio associated with the hawkers for the items via a play sound option.

FIG. 1J is a diagram depicting touch-based customized delivery times for items to event members during an event, according to an example embodiment.

When a user selects a delivery option, app 123 presents a list of delivery options to the user that are based on a point in time associated with the event or user-defined as illustrated in FIG. 1J. This causes order service 114 to use the appropriate APIs to order the items selected and schedule delivery of the items through deliver service 144.

A variety of variations on the above-discussed embodiments are achievable with system 100. For example, a user can organize a party, place an order, and send an invitation for the party to select users through app 123 and gameday service 113. If contributions are desired by the party organizer, the invitation can include an AR rendered image of the party table and items ordered along with prices of the items and a link to pay the party organizer via a cash payment service (as discussed above). Selfies of the user with delivered items or with the AR rendered table comprising the items can be shared via social media and posted on behalf of the user via gameday service 113. The empty seats may be populated with fans that span multiple parties or groups, such that each group it appears that the seats at the event location are full (this requires permission from the users to share their image across groups).

The broadcaster may interact with the groups through requests communicated through gameday service 113 with apps 123. For example, the broadcaster may want to showcase the party on the actual jumbotron at the event location or air video or images of the party during the broadcast separately from the jumbotron. Selected parties may then be broadcast by the broadcaster during the broadcast and/or actually streamed on the jumbotron at the event location. In this way, site services 133 may interact with parties through gameday service 113 and apps 123 to propose promotions or contests and/or obtain profiles/statistics about specific parties or all the parties. The information can then be shared by the broadcasters during the live broadcast. Video clips of the party from apps 123 may be submitted through gameday service 113 to site services 133, which broadcaster can randomly select and air during the broadcast.

At predefined times during an event or at random times, gameday service 113 may activate a hawker feature that causes the apps to hear a hawker that is pitching a specific item along with its corresponding image through device 120. Gameday service 113 may have specific promoted items that are pitched during the hawker features based on prearranged agreements between an enterprise associated with cloud 110 and retailers associated with the promoted items. Gameday service 113 may keep track of how many parties/users heard and saw the promoted item and how may parties/users purchase the promoted item.

Demographics associated with users and parties that purchase and do not purchase the promoted items may be retained along with what types of events, timing of the hawker feature during the event, types of promoted items, etc. for purposes of achieving a better purchase rate of a given promoted item or any promoted item provided via the hawker feature during an event.

The timing to initiate the hawker feature can be calculated to ensure that items desired by a group are capable of being delivered to the group at desired times, such as before the game, at halftime, etc. This can be based on metrics associated with preparing the items and delivering the prepared items to a given location associated with the party. For example, when item preparation or fulfillment times and estimated delivery times are calculated, a lead time is determined and when that lead time for a given party location is within a configured amount of time before a desirable time associated with the event, gameday service 113 initiates the hawker feature on apps 123.

App 123 may provide a selectable option before, during, and after the game to access the AR rendered concession stand the available items, such that users can order items at any time desired and select a desired delivery time.

In an embodiment, an AR rendered spirit wear shop may be rendered through AR manager 115 for purchase of spirit wear. The hawker feature may also pitch spirit wear items in the manners discussed above.

In an embodiment, users can play the sound of a hawker for friends at the party to encourage the users to place their order for alcohol or food items.

In an embodiment, AR manager 115 permits selfies of the users to be edited for augmenting the selfies with spirt wear that was not actually present in the selfies but was desired by a given user when presenting their selfies. For example, team shirts and hats may be added to the selfies upon selection by the users.

In an embodiment, user-operated device 120 is a phone, a tablet, a desktop, a laptop, or a wearable processing device (e.g., smart glasses, watch, etc.).

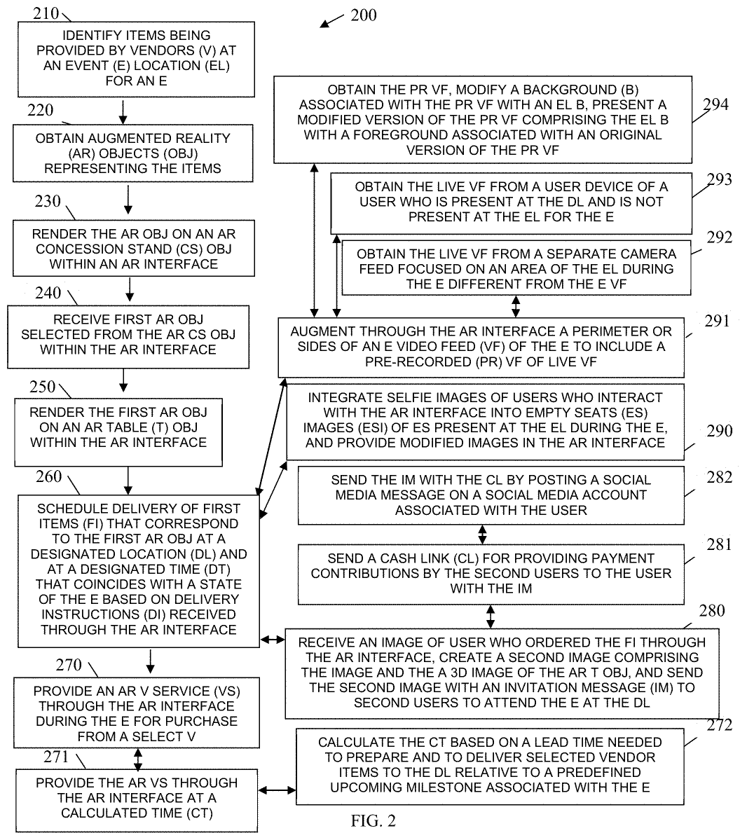

The above-noted embodiments and other embodiments are now discussed with FIG. 2.

FIG. 2 is a diagram of a method 200 for real-time AR event-based service, according to an example embodiment. The software module(s) that implements the method 200 is referred to as an “AR event integrator.” The AR event integrator is implemented as executable instructions programmed and residing within memory and/or a non-transitory computer-readable (processor-readable) storage medium and executed by one or more processors of one or more devices. The processor(s) of the device(s) that executes the AR event integrator are specifically configured and programmed to process the AR event integrator. The AR event integrator may have access to one or more network connections during its processing. The network connections can be wired, wireless, or a combination of wired and wireless.

In an embodiment, the AR event integrator executes on cloud 110. The cloud 110 comprises one or more servers that are logically assembled and cooperate as a single server.

In an embodiment, the AR event integrator is all of or some combination of 113-116.

At 210, the AR event integrator identifies item being provided by vendors at an event location for an event. The AR event integrator uses an API to interact with site services 133 associated with the event for identifying the vendors; AR event integrator uses a same or different API to contact the catalogue services 143 associated with the vendors and identify item identifiers for the items that are going to be offered and provided during the event at the event location.

At 220, the AR event integrator obtains AR objects representing the items; the item identifiers are mapped to predefined 3D images for the corresponding items.

At 230, the AR event integrator renders the item AR objects on an AR concession stand object within an AR interface. In an embodiment, the AR interface is mobile app 123 as discussed above with system 100.

At 240, the AR event integrator receives first item AR objects selected from the AR concession stand object within the AR interface.

At 250, the AR event integrator renders the first AR item objects on an AR table object within the AR interface.

At 260, the AR event integrator schedules delivery of first items that correspond to the first item AR objects to a designated location and at a designated time that coincides with a state of the event based on delivery instructions received through the AR interface.

In an embodiment, at 270, the AR event integrator provides an AR vendor service (hawker service discussed above with system 100) through the AR interface during the event for purchase of a select vendor.

In an embodiment of 270 and at 271, the AR event integrator provides the AR vendor service through the AR interface at a calculated time during the event.

In an embodiment of 271 and at 272, the AR event integrator calculates the calculated time based on a lead time needed to prepare and to deliver selected vendor items to the designated location relative to a predefined upcoming milestone associated with the event.

In an embodiment, at 280, the AR event integrator receives an image of a user who ordered the first items through the AR interface. The AR event integrator creates a second image that comprises the image and a 3D image of the AR table object and sends the second image with an invitation message to second users to attend the event at the designated location.

In an embodiment of 280 and at 281, the AR event integrator sends a cash link for providing payment contributions by the second users to the user with the invitation message.

In an embodiment of 281 and at 282, the AR event integrator sends the invitation message with the cash link by posting a social media message on a social media account associated with the user.

In an embodiment, at 290, the AR event integrator integrates selfie images of users who interact with the AR interface into empty seats images of empty seats present at the event location during the event. The AR event integrator provides modified images within the AR interface; the modified images comprise the selfie images of the users appearing to be in the empty seats at the event location during the event.

In an embodiment, at 291, the AR event integrator augments, through the AR interface, a perimeter or sides of an event video feed for the event to include one or more pre-recorded video feeds and/or one or more live video feeds.

In an embodiment of 291 and at 292, the AR event integrator obtains at least one live video feed from a separate camera feed focused on an area of the event location during the event that is different from the event video feed.

In an embodiment of 291 and at 293, the AR event integrator obtains at least one live video feed from a user device of a user who is present at the designated location and is not present at the event location for the event.

In an embodiment of 291 and at 294, the AR event integrator obtains at least one pre-recorded video feed and modifies a background associated with the pre-recorded video feed with an event location background to create a modified version of the pre-recorded video feed. The modified version of the pre-recorded video feed comprises the event location background with a foreground associated with an original version of the pre-recorded video feed.

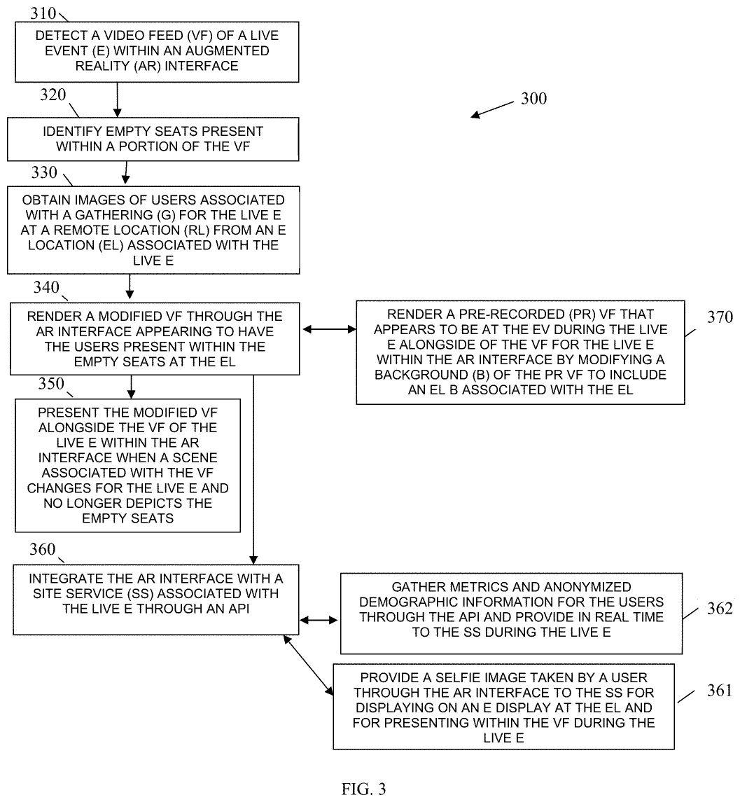

FIG. 3 is a diagram of a method 300 for real-time AR event-based service, according to an example embodiment. The software module(s) that implements the method 300 is referred to as a “AR gameday service.” The AR gameday service is implemented as executable instructions programmed and residing within memory and/or a non-transitory computer-readable (processor-readable) storage medium and executed by one or more processors of one or more devices. The processor(s) of the device(s) that executes the AR gameday service are specifically configured and programmed to process the AR gameday service. The AR gameday service may have access to one or more network connections during its processing. The network connections can be wired, wireless, or a combination of wired and wireless.

In an embodiment, the AR gameday service executes on cloud 110.

In an embodiment, the AR gameday service is all of, or some combination of 113-116 and/or the method 200.

The AR gameday service represents another and, in some ways, an enhanced processing perspective from that which was discussed above with method 200 and/or system 100.

At 310, the AR gameday service detects a video feed of a live event within an AR interface.

At 320, the AR gameday service identifies empty seats present within a portion of the video feed.

At 330, the AR gameday service obtains images of uses associated with a gathering (party or group) for the live event at a remote location from an event location associated with the live event.

At 340, the AR gameday service renders a modified video feed through the AR interface appearing to have the users present within the empty seats at the event location during the live event.

In an embodiment, at 350, the AR gameday service presents the modified video feed alongside the video feed of the live event within the AR interface when a scene associated with the live video feed changes for the live event and no longer depicts the empty seats.

In an embodiment, at 360, the AR gameday service integrates the AR interface with a site service 133 associated with the live event through an API.

In an embodiment of 360 and at 361, the AR gameday service provides a selfie image taken by a user through the AR interface to the site service 133 for displaying on an event or site device 114 (e.g., a jumbotron at the event location) and for presenting within the video feed during the live event.

In an embodiment of 360 and at 362, the AR gameday service gathers metrics and anonymized demographic information for the users through the API and provides in real time to the site service 133 during the live event.

In an embodiment, at 370, the AR gameday service renders a pre-recorded or live-streamed video feed that appears to be at the event location during the live event alongside of the video feed for the live event within the AR interface by modifying a background of the pre-recorded video feed to include an event location background associated with an area of the event location.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying items being provided by vendors at an event location for an event;
obtaining Augmented Reality (AR) objects representing the items;
rendering the AR objects on an AR concession stand object within an AR interface;
receiving first AR objects selected from the AR concession stand object within the AR interface;
rendering the first AR objects on an AR table object within the AR interface; and
scheduling delivery of first items that correspond to the first AR objects at a designated location and at a designated time that coincides with a state of the event based on delivery instructions received through the AR interface.

2. The method of claim 1 further comprising, providing an AR vender service through the AR interface during the event for purchase of select items from a select vendor.

3. The method of claim 2, wherein providing further includes providing the AR vender service through the AR interface at a calculated time during the event.

4. The method of claim 3, wherein providing further includes calculating the calculated time based on a lead time needed to prepare and to deliver the select items to the designated location relative to a predefined upcoming milestone associated with the event.

5. The method of claim 1 further comprising, receiving an image of a user who ordered the first items through the AR interface, creating a second image comprising the image and a three-dimensional image of the AR table object, and sending the second image along with an invitation message to second users to attend a gathering for the event at the designation location.

6. The method of claim 5, wherein sending further includes sending a cash link for providing payment contributions by the second users to the user with the invitation message.

7. The method of claim 6, wherein sending further includes sending the invitation message and the cash link by posting a social media message on a social media account associated with the user.

8. The method of claim 1 further comprising, integrating selfie images of users who interact with the AR interface into empty seat images of empty seats present at the event location during the event and providing modified images comprising the selfie images appearing to be present within the empty seats during the event through the AR interface.

9. The method of claim 1 further comprising, augmenting, through the AR interface, a perimeter or sides of an event video feed of the event to include one or more pre-recorded video feeds or one or more live video feeds.

10. The method of claim 9, wherein augmenting further includes obtaining at least one live video feed from a separate camera feed focused on an area of the event location during the event different from the event video feed.

11. The method of claim 9, wherein augmenting further includes obtaining at least one live video feed from a user-device of a user that is present at the designated location and not present at the event location for the event.

12. The method of claim 9, wherein augmenting further includes obtaining at least one pre-recorded video feed, modifying a background associated with the at least one pre-recorded video feed with an event location background, and presenting a modified version of the at least one pre-recorded video feed comprising the event location background with a foreground associated with an original version of the at least one pre-recorded video feed.

13. A method, comprising:
detecting a video feed of a live event within an Augmented Reality (AR) interface;
identifying empty seats present within the video feed;
obtaining images of users associated with a gathering for the live event at a remote location from an event location associated with the live event; and
rendering a modified video feed through the AR interface appearing to have the images of the users present within the empty seats at the event location.

14. The method of claim 13 further comprising, presenting the modified video feed alongside the video feed of the live event with the AR interface when a scene associated with the video feed changes for the live event and no longer depicts the empty seats.

15. The method of claim 13 further comprising, integrating the AR interface with a site service associated with the live event through an Application Programming Interface (API).

16. The method of claim 15, wherein integrating further includes providing at least one selfie image taken by one of the users through the AR interface to the site service for displaying on an event display device at the event location and for presenting within the video feed during the live event.

17. The method of claim 15, wherein integrating further includes gathering metrics and anonymized demographic information for the users through the API and providing in real time to the site service during the live event.

18. The method of claim 13 further comprising, rendering a pre-recorded video feed that appears to be at the event location during the live event alongside of the video feed for the live event within the AR interface by modifying a background of the pre-recorded video feed to include an event location background associated with the event location.

19. A system comprising:
a cloud processing environment comprising at least one server;
the at least one server comprising at least one processor and a non-transitory computer-readable storage medium;
the non-transitory computer-readable storage medium comprising executable instructions; and
the executable instructions when executed by the at least one processor from the non-transitory computer-readable storage medium cause the at least one processor to perform operations comprising:
providing an Augmented Reality (AR) interface to user-operated devices associated with users of a group, wherein the group participating remotely in a live event at a remote location from an event location that is associated with the live event;
rendering a first AR object within the AR interface depicting a three-dimensional (3D) concession stand with items for purchase and delivery to the group at the remote location;
rendering a second AR object within the AR interface depicting a 3D party table that comprises selected items by the group from the first AR object;
scheduling delivery of the selected items to the remote location to coincide with a user-defined point in time relative to a progression of the live event;
providing an AR vendor service through the AR interface, wherein the AR vendor service is launched within the AR interface to account for a lead time associated with preparing vendor items and delivering the vendor items to the remote location before a start of or after an end of a milestone associated with the progression of the live event; and
providing a modified video feed that comprises one or more images of one or more of the users appearing to be present at the event location during the live event alongside of the video feed for the live event within the AR interface.

20. The system of claim 19, wherein the user-operated devices comprise mobile phones, tablets, laptops, or wearable processing devices.
